(19) United States
(12) Patent Application Publication
(10) Pub. No.: US 2004/0116108 A1
(43) Pub. Date: Jun. 17, 2004

(54) Internet phone system and internet phone service method for a mobile telephone

(76) Inventor: In-Sik Ra, Seoul (KR)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 10/691,298

(22) Filed: Oct. 22, 2003

(30) Foreign Application Priority Data
Dec. 17, 2002 (KR) 10-2002-0080677

(51) Int. Cl. H04M 3/00

(52) U.S. Cl. 455/418; 455/419

(57) ABSTRACT

An Internet phone system and an Internet phone service method can connect a conventional wire telephone to a mobile communication network not via PSTN but via the Internet. The system includes a telephone; a connection converting apparatus for connecting the telephone to either the Internet or a PSTN; a user's computer in which software is installed for connecting the telephone to the Internet through the connection converting apparatus; a VoIP gateway for connecting a mobile communication network to the Internet; and a mobile telephone for accessing the Internet. The connection converting apparatus includes: a hook detector for detecting a hooked state of the telephone; a relay for connecting the telephone to either the Internet or the PSTN according to a commmand; a duplex circuit for suppressing voice leakage and side tone by converting and reconverting from a two-line signal of the telephone to a four-line signal for transmission and reception; a tone decoder for decoding a DTMF tone of the telephone; and a microprocessor for exchanging control data for the user's computer, controlling the relay to cause the telephone to be connected to the Internet when the hook detector detects an off-the-hook state of the telephone, and providing number data to the user's computer when the microprocessor receives number data from the tone decoder.

### BACKGROUND OF THE INVENTION

1. Field of the Invention

The present invention relates to a technique of combining an Internet phone and a mobile telephone, and more particularly to an Internet phone system and an Internet phone service method that can connect a conventional wire telephone to a mobile communication network not via PSTN but via the Internet.

2. Description of the Prior Art

As generally known in the art, an Internet phone, called an IP phone, converts an analog voice signal into a digital coding signal and transfers the digital signal to the receiving party not through PSTN but through the Internet (Packet Communication Network), thereby providing a telephone service. For this service, an Internet phone digitalizes and compresses an analog voice signal at 64 Kbps, and transmits the voice signal of 64 Kbps via a packet network according to a transmission standard protocol such as H.323, etc.

According to what types of terminals are used at both ends, Internet phones may be classified into three types: PC-to-PC, PC-to-phone, and phone-to-phone. Also, techniques such as a voice coding and compression technique, a real time data transmission technique, a packet correcting technique, a gateway technique, etc., are used in Internet phones. In the coding of voice information, a low bit rate, a high compression rate and a coding for the high voice quality are applied in transmitting without decreasing the quality of voice. Voice coding techniques such as PCM, adaptive prediction coding, GSM, LPC, etc., have been used. However, RTP, the Internet transmission quality of which has been approved since 1995, is mainly used.

In the PC-to-PC Internet phone, headsets are connected to each of two PCs, and a dedicated program is executed in the two PCs in order for them to communicate with each other. For the two PCs to call each other, a service provider operates a server and provides IP information for connection between the two PCs. Also, it is possible to establish a call when the computer of the receiving party is turned on and the PC is registered in the server.

In the PC-to-phone type, PC of the receiving party is connected to an Internet phone service provider in the state in which the PC is connected to the Internet. The Internet phone service provider installs a gateway at a PSTN switching center that is placed near to an area in which the receiving party resides, and causes a call between the calling party and the receiving party to be established. For example, when a call is generated between Seoul and New York, the international communication of the call is established via the Internet and each local communication is established via local telephone networks of each city. Therefore, in the case PC-to phone connection, the Internet phone service provider only pays fees for using the local telephone network and maintaining the gateway for international calls, thereby providing an international telephone service at a lower cost.

The phone-to-phone type is more developed than the PC-to-phone type. In the phone-to-phone communication, a subscriber dials a particular number (a switching center of a service provider) for a call to be connected with the service provider. The call is transferred to a receiving party via a gateway of the receiving party and a gateway with Internet packets of the receiving party. The Internet packets are translated into a general call, and provided to the receiving party through a PSTN switching center of an area in which the receiving party resides. This phone-to-phone type provides a long distance telephone service at a lower cost by using the Internet as the link between the gateway of the calling party and the gateway of the receiving party.

As mentioned above, up to this time, Internet phones have provided service by substituting the Internet for a part of PSTN using a general PSTN telephone or a PC as a terminal.

On the other hand, each current mobile communication provider structures or rents mobile communication networks only for themselves, set apart from the PSTN, and provides the communication between mobile terminals as a basic service. Also, mobile communication providers provide communication between the mobile terminals and the telephones by connecting the mobile communication networks and the PSTN.

However, this way of allowing a mobile telephone (or telephone) to communicate with another telephone (or mobile telephone) generates an additional communication cost due to using the PSTN. Considering benefit distribution rate, when a call is performed between the subscribers subscribing to the same mobile communication provider (for example, between mobile phones having the numbers of 019-111-2222 and 019-333-4444), 100% of the benefit for the call is given to the mobile communication provider, determined by the mobile phone of the calling party. However, when the call is established through any other mobile communication provider (for example, between mobile phones having the numbers of 019-xxx-yyyy and 016-xxx-yyyy), the benefit for the call is shared between both the providers at a licensed rate. When a call is established between a telephone and a mobile phone, a PSTN provider in Korea, Korea Telecom (KT) receives a portion of the benefit for the call as the telephone line provider.

In this structure of sharing a benefit for mobile communication service, because KT has a monopoly on the PSTN in Korea, the benefit sharing structure is relatively unfavorable to mobile communication providers. From the perspective of users, the mobile communication fee is a problem because the users pay an additional fee for using the PSTN as well as the fee for using a mobile communication network. Therefore, if the call between a mobile phone and a telephone is established without using the PSTN, the call can be implemented at a lower cost.

### SUMMARY OF THE INVENTION

Accordingly, the present invention has been made to solve the above-mentioned problems occurring in the prior art, and an object of the present invention is to provide an Internet phone service method that can connect a conventional wire telephone to a mobile communication network not via PSTN but via the Internet.

In order to accomplish this object, there is provided an apparatus according to the present invention which comprises: a telephone; a connection converting apparatus for connecting the telephone to either the Internet or a PSTN; a user's computer in which a software is installed for connecting the telephone to the Internet through the connection converting apparatus; a VoIP gateway for connecting a mobile communication network to the Internet; and a mobile telephone for accessing the Internet. Further, the connection converting apparatus includes: a hook detector for detecting a hooking state of the telephone; a relay for connecting the telephone to either the Internet or the PSTN according to control; a duplex circuit for suppressing voice leakage and side tone by converting and reconverting from the two-line signal of the telephone to a four-line signal for transmission and reception; a tone decoder for decoding a DTMF tone of the telephone; and a microprocessor for exchanging control data from the user's computer, controlling the relay to cause the telephone to be connected to the Internet when the hook detector detects a hook-off of the telephone, and providing number data to the user's computer when the microprocessor receives the number data from the tone decoder.

In order to accomplish this object, there is provided a method according to the present invention that allows a user of a telephone to communicate with a subscriber of a mobile communication network by a process of originating a call to a subscriber of a mobile communication network or a process of receiving a call requested by a subscriber of a mobile communication network. The method includes an originating process and a receiving process, the originating process comprising the steps of receiving an IP address when the telephone is off the hook and inputting a number of a mobile phone, transmitting the number of the mobile phone and the IP address to a VoIP gateway of a mobile communication network defined by the number in order to request a call, and performing a predetermined call process through the VoIP gateway in order to connect the telephone with the mobile phone; and the receiving process comprising the steps of determining whether a computer of the user of the telephone is in an on-line state when a subscriber of a mobile communication network calls the user of the telephone, calling the user of the telephone using an IP address when the computer is in the on-line state; and allowing the telephone and the mobile phone to communicate with each other when the user takes the telephone off the hook in response to the call; whereby the user communicates with the subscriber of a mobile communication network not via PSTN but via the Internet.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic view showing an overall structure of an Internet phone system according to the first embodiment of the present invention;

FIG. 2 is a block diagram of the connection converting apparatus depicted in FIG. 1;

FIG. 3 is a flowchart illustrating the operation of the connection converting apparatus depicted in FIG. 2;

FIG. 4 is a flowchart illustrating an operation of the Internet phone software of the computer depicted in FIG. 1;

FIG. 5 is a flowchart showing the process of a call from a telephone to a mobile phone according to the first embodiment of the present invention;

FIG. 6 is a flowchart showing the process of a call from a mobile phone to a telephone according to the first embodiment of the present invention; and

FIG. 7 is a schematic view showing an overall structure of an Internet phone system according to the second embodiment of the present invention.

### DESCRIPTION OF THE PREFERRED EMBODIMENTS

Hereinafter, a preferred embodiment of the present invention will be described with reference to the accompanying drawings.

First, since the present invention uses not PSTN but the Internet for connecting a mobile phone and a telephone, a user needs a computer and a very high speed communication network (an ADSL modem, a cable modem, etc.) for accessing the Internet, and a mobile communication network needs a VoIP (Voice Over Internet Protocol) gateway to be connected with the Internet. Also, for utilizing a service according to the present invention, a “connection converting apparatus” for connecting a telephone to the Internet or the PSTN is needed as a subscriber apparatus. Also, dedicated software (hereinafter, referred to as Internet phone software) for driving an Internet phone must be installed in a computer connected with the connection converting apparatus.

Further, there are a central concentration type and a base station distribution type for applying the VoIP gateway to the mobile communication network. The central concentration type connects all Internet phones with one another using leased networks of a concerned mobile communication service provider. The base station distribution type disperses loads by installing gateways, which are connected to the Internet, in each base station. For helping to understand the embodiments according to the present invention, the central concentration type will first be described in the first embodiment and the base station distribution type will be described in the second embodiment.

First Embodiment

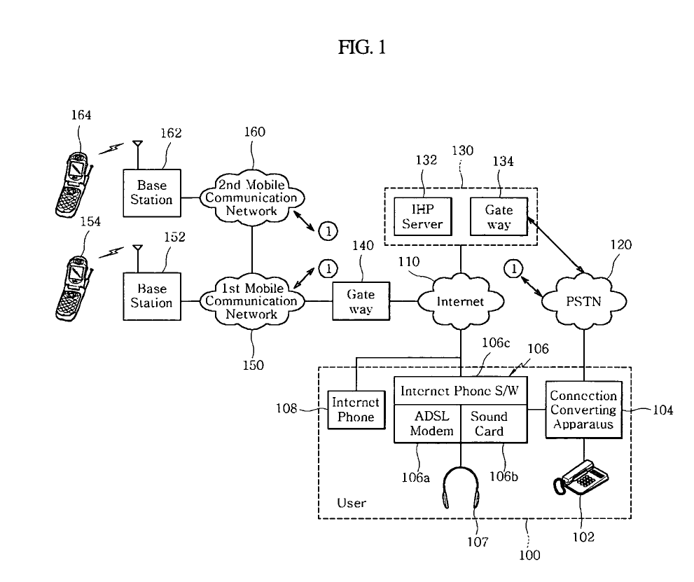

FIG. 1 is a view showing an overall structure of an Internet phone system according to the present invention.

Referring to FIG. 1, a telephone 102 is connected to a PC 106 and PSTN 120 via a connection converting apparatus 104. The PC 106 is connected with the Internet via a very high-speed communication network. A server 132 of a provider 130 (hereinafter, referred to as an IHP provider) that provides a service for connecting the telephone 102 with a mobile phone (or hand phone) via the Internet according to the present invention is connected with the Internet 110. The server 132 of the IHP provider 130 is also connected with the PSTN 120 through a gateway 134. The first mobile communication provider manages the first mobile communication network 150. The first mobile communication network 150 is connected with the Internet through a VoIP gateway 140, which is managed in a communication service provider leased network. The first mobile communication service provider provides a mobile communication service to its subscribers 154 through base stations 152 of the first mobile communication network 150. The second mobile communication service provider manages the second mobile communication network 160 and provides a mobile communication service to its subscribers 164 through base stations 162 of the second mobile communication network 160. The first and second mobile communication networks include MSCs (Mobile Switching Center), HLRs (Home Location Resister) having a database of subscriber location information, a dedicated network for fee charging and an NMS (Network Management System).

The PC 106 includes an ADSL modem 106a for accessing the Internet and a sound card 106b. A driver, an operation system (O/S), and various application programs are installed in the PC 106. Particularly, for performing the service according to the present invention, Internet phone software 106c is installed in the PC 106. Further, when the connection converting apparatus 104 is not used, an Internet phone 108 is used to perform a call via the Internet and a mobile communication network in the state in which a head set 107 is connected to the soundcard 106b.

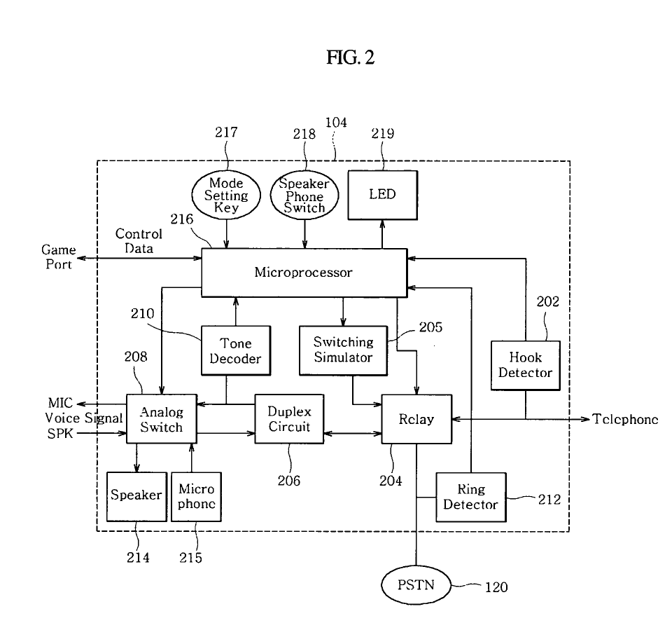

FIG. 2 is a block diagram of the connection converting apparatus 104 depicted in FIG. 1. The connection converting apparatus 104 includes a hook detector 202, a relay 204, a switching simulator 205, a duplex circuit 206, an analog switch 208, a tone decoder 210, a ring detector 212, a speaker 214, a microphone 215, and a microprocessor 216. The connection converting apparatus 104 connects the telephone 102 to the Internet 110 or the PSTN 120.

The connection of the connection converting apparatus 104 and the PC 106 is implemented through a voice signal connecting port and a control data connecting port. The voice signal connecting port is connected to a speaker terminal spk and a microphone terminal mic of the soundcard 106b. A communication port, such as a USB port, a serial port, etc., may be used as the control data connecting port. In the present embodiment, a game port is used as the control data connecting port. Further, when connecting the connection converting apparatus 104 to the PC 106 through the USB port, all the voice and control data can be transmitted through the USB port. The telephone 102 is connected to the connection converting apparatus 104 through an RJ11 jack.

When the connection converting apparatus 104 has a speaker 214 and a microphone 215 which are installed in the connection converting apparatus 104, in a “speaker phone mode”, the connection converting apparatus 104 can perform a call without the telephone 102. When the connection converting apparatus 104 is connected to the telephone 102, the telephone 102 can be used in either a “general telephone mode” or an “Internet phone mode”. If the connection converting apparatus 104 is set to the “general telephone mode”, the telephone 102 is connected to the PSTN 120 as in the prior art. If the connection converting apparatus 104 is set to the “Internet phone mode”, the telephone 102 is connected to the Internet and used as an Internet phone. In the Internet phone mode, the telephone is connected to the PSTN 120 while the telephone waits for a call that is requested through the PSTN 120.

Referring to FIG. 2, a mode setting key 217 is provided for setting the connection converting apparatus 104 to either the general telephone mode or the Internet phone mode. A speaker phone switch 218 is provided for a telephone conversation using the speaker 214 and the microphone 215 installed in the connection converting apparatus 104. An LED 219 is used for denoting a reception of a call signal while the telephone is engaged in the Internet mode or for informing the fact that the telephone is calling through the Internet.

The hook detector 202 detects whether the telephone 102 is off the hook or not and informs the microprocessor 216 of the state of the telephone. The relay 204 causes the telephone 102 to be connected to the PSTN 120 in the general telephone mode according to the control of the microprocessor 216. In the Internet phone mode, the relay 204 connects the telephone 102 to the PSTN on standby. Then, when the telephone is detected to be off the hook, the relay 204 causes the telephone 102 to be connected to the duplex circuit 206 to establish a call the Internet.

The switching simulator 204 performs a function as an exchanger of PSTN to provide an originating and receiving signal and a loop power when the telephone is used as an Internet phone. The duplex circuit 206 divides two wire signals 2W that are inputted and outputted through the telephone 102 into an input signal and an output signal on four wires.

The duplex circuit 206 also performs a role of preventing interference between sending and receiving voices. That is, even though the telephone 102 has a tip terminal and a ring terminal, because it is necessary to divide the two terminals into transmission TX and reception RX at a transmission line, the duplex circuit 206 performs a 2W-to-4W conversion.

The analog switch 208 connects the microphone and speaker terminals MIC and SPK of the soundcard to the duplex circuit 206 at the steady state according to the control of the microprocessor 216. When the speaker phone switch 218 is operated, the analog switch 208 connects the speaker 214 and the microphone 215 on the apparatus to the duplex circuit 206, so that a call can be established without the telephone 102.

The tone decoder 210 decodes a DTMF tone generated when a button of the telephone 102 is pushed, generating number data, and provides the number data to the microprocessor 216. The ring detector 212 detects a ring signal inputted through the PSTN 120 and informs the microprocessor 216 of the detection result.

When the general telephone mode has been set by the mode key 217, the microprocessor 216 controls the relay 204 to maintain the telephone 102 connection with the PSTN 120. When the Internet phone mode is set, the microprocessor 216 controls the relay 204 to connect the telephone 102 to the PSTN 120 in a steady state and to connect the telephone 102 the duplex circuit 206 when a hook-off state of the telephone 102 is detected, so that a call is performed through the Internet. Further, when the speaker phone switch 218 is operated, the microprocessor 216 controls the analog switch 208 to connect the embedded speaker 214 and the embedded microphone 215 to the PC, so that the user may have a conversation with a receiving party using the embedded speaker 214 and the embedded microphone 215. The microprocessor 216 communicates with the PC 106, causing the PC to drive the Internet phone software 106c. Also, the microprocessor 216 transmits the number of a receiving party while originating a call, and performs a receiving instruction while receiving a call signal.

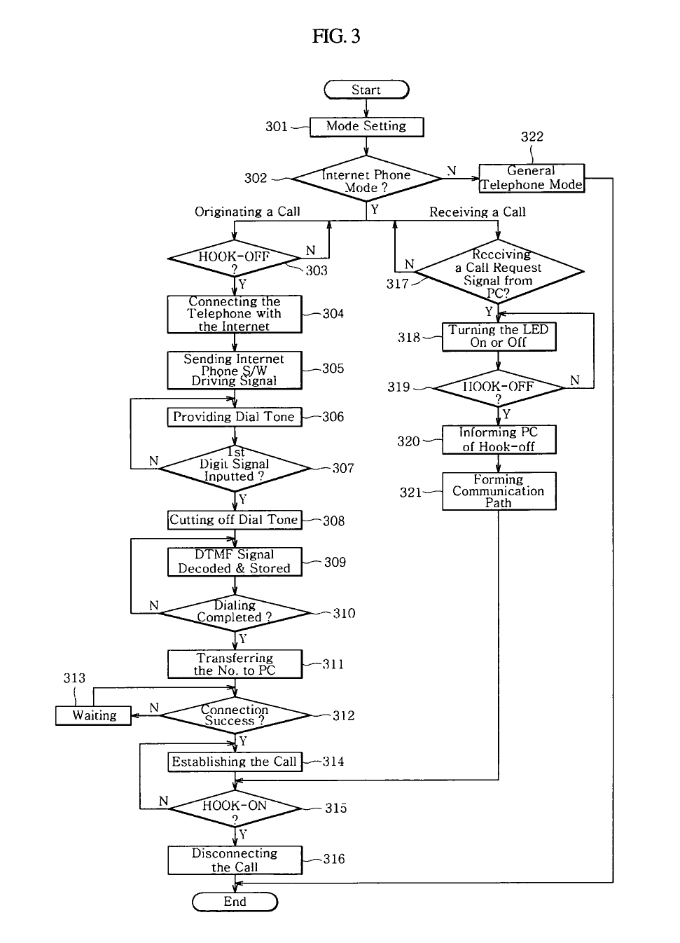

FIG. 3 is a flowchart of illustrating the operation of the connection converting apparatus depicted in FIG. 2.

Referring to FIG. 3, the connection converting apparatus 104 causes the telephone to be kept in connection with the PSTN in the general telephone mode (322). In the Internet mode, when a user takes the telephone 102 off the hook in order to originate a call, the hook-off state of the telephone is detected by the hook detector 202 and informed to the microprocessor 216. Then, the microprocessor 216 controls the relay 204, connecting the telephone with the Internet (301-304).

Then, the microprocessor 216 sends an Internet phone software driving signal to the PC 106 through the game port to request the PC to drive the Internet phone software (305). Then, the microprocessor 216 controls the switching simulator 205 to provide a dial tone to the telephone 102 (306).

The user hears the dial tone and dials a telephone number (307). At this time, when the first digit signal is inputted, the dial tone is cut off. The DTMF signal is decoded by the DTMF decoder 210 and temporarily stored in the microprocessor 216 (308, 309). When the dialing is completed, the microprocessor 216 transfers the number of the receiving party to the Internet phone software of the PC (310, 311).

Further, the microprocessor 216 establishes the call when receiving a connection success signal. If the connection success signal is not received however, the microprocessor 216 waits until that signal is received (312-314).

When it has been detected that the telephone has been hung up during the connection, the microprocessor 216 transmits a call disconnection signal and disconnects the call (315, 316). At this time, the microprocessor 216 controls the relay 204 to connect the telephone 102 to the PSTN 120 again.

On the other hand, when the microprocessor 216 receives a call request signal from the user's computer 106, the microprocessor 216 turns the LED 219 on or off in order to inform the user of the call request. When the user takes the telephone 102 off the hook and the hook detector detects this state of the telephone 102, the microprocessor 216 informs the computer 106 of this fact and forms a communication path (317-321). At this time, the call request may be denoted on the computer screen by a character or an image, or by means of sound through a computer speaker, the telephone speaker or a beeper in the connection converting apparatus.

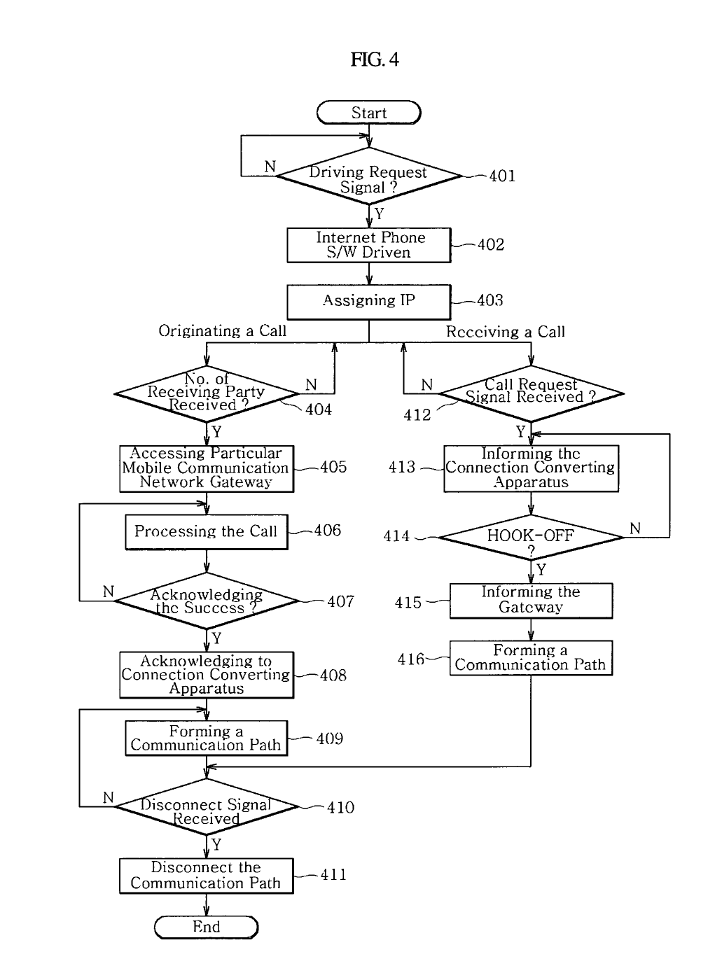

FIG. 4 is a flowchart illustrating an operation of the Internet phone software of the computer depicted in FIG. 1.

Referring to FIG. 4, when the Internet phone software 106c receives a driving request signal from the connection converting apparatus 104, the Internet phone software 106c is driven. When the Internet phone software 106c is driven, an Internet service provider (ISP) assigns a temporary or fixed IP to the Internet phone software 106c to be connected to the Internet. At this time, the Internet phone software 106c preferably is connected to the server 132 to inform the server 132 of the assigned IP (401-403).

When the number of the receiving party is received from the connection converting apparatus 104, the Internet phone software 106c accesses a particular mobile communication network gateway 140 and requests the gateway 140 to process the call (405, 406). Further, the Internet phone software 106c may be indirectly connected to the gateway 140 via the server 132.

When the Internet phone software 106c succeeds in the connection to the mobile communication network through the gateway 140, the Internet phone software 106c acknowledges the success in the connection to the connection converting apparatus 104 and forms a communication path to establish the call. Then, when a disconnect signal is received, the Internet phone software 140 disconnects the communication path (407-411).

On the other hand, looking into the process of receiving a call request, when a call request signal from the gateway 140 is received, the Internet phone software 106c informs the connection converting apparatus 104 of the reception of the call request signal. When the fact of the telephone being off the hook is received from the connection converting apparatus 104, the Internet phone software 106c informs the gateway 140 of this fact and forms a communication path (412-416).

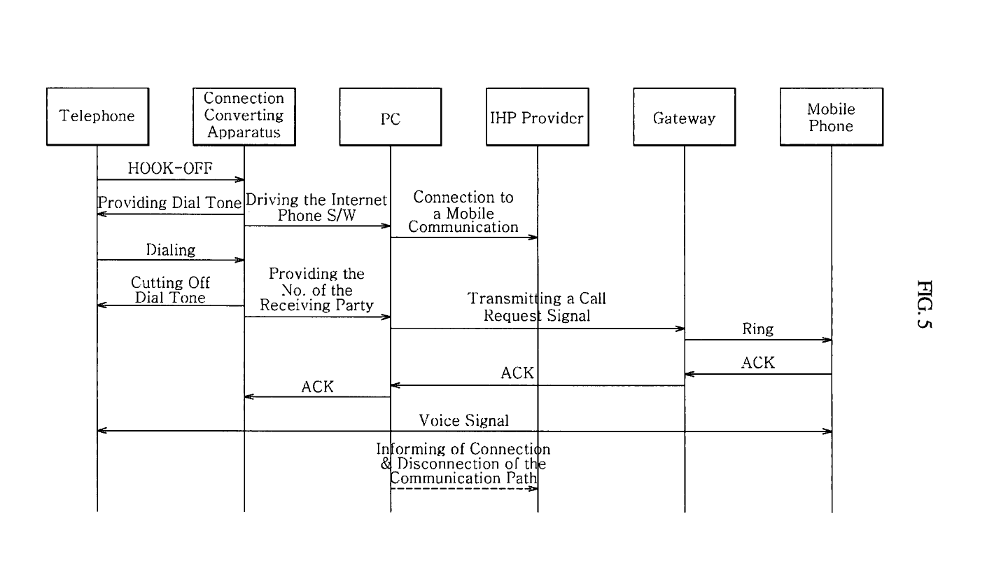

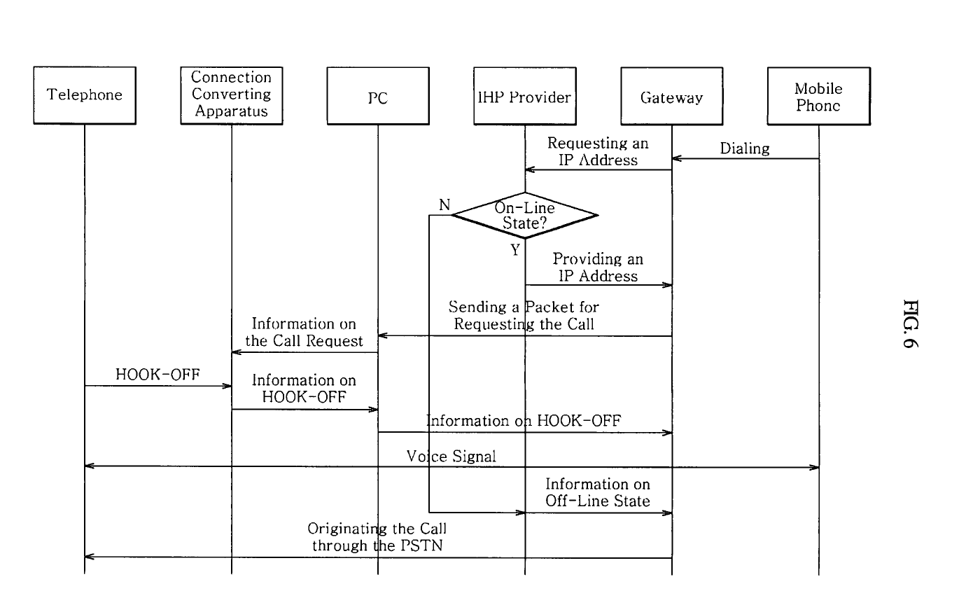

In this configuration, the process of transmitting an originating signal from a telephone to a mobile phone is shown in FIG. 5, and the process of transmitting a call request signal from the mobile phone to the telephone is shown in FIG. 6.

Referring to FIG. 5, if the Internet phone mode is selected by a switch of the connection converting apparatus 104 and the fact of the telephone 102 being off the hook is detected by the hook detector 202, the relay 204 connects the telephone 102 to the Internet according to the control of the microprocessor 216. The microprocessor 216 controls the switching simulator 205 to provide the dial tone to the telephone 102 and requests the user's computer to drive the Internet phone software.

Then, a user dials 019-239-0021, a number of a receiving party, using the telephone 102.

The DTMF decoder 210 of the connection converting apparatus decodes a DTMF signal generated from the telephone 102 and provides the decoded DTMF signal to the microprocessor 216. The microprocessor 216 analyzes received digits and determines whether an adequate number of digits, for example, 10 digits, have been received. When 10 digits are received, the microprocessor 216 communicates with the PC 106 to provide the number of the receiving party to the PC 106.

When the number of the receiving party is received, the Internet phone software 106c of the PC 106 converts the number of the receiving party into packets according to the Internet protocol and transmits the packets to the gateway together with its own IP address. In the indirect method, the number of the receiving party is converted into packets and transmitted with the IP address to the IHP server 132. The IHP server 132 analyzes the received packets, transmitting the received packets to an appropriate VoIP gateway 140 of a mobile communication network.

The VoIP gateway 140 analyzes the Internet packets in order to detect the number of the receiving party and the IP of the calling party, and starts a call process. When the receiving party is not a subscriber of a mobile communication network, the VoIP gateway 140 is connected to a mobile communication network of a provider that serves the number according to a conventional process.

When the receiving party is a subscriber of a mobile communication network, the mobile communication network 150 searches HLR for a base station currently serving the receiving party and transmits a call request signal to the base station. Then, the base station calls the receiving party through a paging channel. If, at this time, the receiving party is busy, the base station informs the calling party of the fact via a reverse path.

When the phone of the receiving party is off the hook, a communication path is established between the VoIP gateway 140 and the mobile phone 154 of the receiving party, and the VoIP gateway transmits a call approval signal ACK to the PC 106 of the calling party. When the call approval signal is received, the Internet phone software 106c of the PC 106 transmits the call approval signal to the connection converting apparatus 104 and establishes a communication path between the calling party and receiving party. In the indirect method, the VoIP gateway 140 transmits a response packet to the IHP server 132 to inform the IHP server 132 that the telephone is off the hook, and then the IHP server 132 transmits this fact to the PC 106 of the calling party.

When the communication path is established, an analog voice signal, which is generated from the telephone 102, is provided to the soundcard 106b of the PC 106 through the duplex circuit 206 of the connection converting apparatus 104 to be converted into digital data. The voice data digitalized in the soundcard 106b are broken up into IP packets by the Internet phone software, and transmitted to the VoIP gateway 140 through the Internet 110. The gateway 140 rearranges the packets to recover the original voice data, and sends the recovered voice data over the mobile communication network 150 to the receiving party 154.

A voice signal of the receiving party is coded in the mobile phone 154 and transmitted to the VoIP gateway 140 via the mobile communication network 150. The VoIP gateway 140 causes the voice data to be broken up into IP packets and sends the IP packets to the PC 106 of the calling party via the Internet. The IP packets sent to the PC 106 is rearranged into the original voice data, and decoded into an analog voice signal by the soundcard 106b. The analog voice signal is sent to the telephone 102 via the connection converting apparatus 104.

In this way, an analog voice signal is used for transmission between the telephone 102 and the PC 106, Internet data (or IP packets) are used for transmission between the PC 106 and the VoIP gateway 140, and a voice signal of a conventional mobile telephone is used for transmission between the VoIP gateway 140 and the mobile phone 164.

On the other hand, when the call is completed and the user hangs up the telephone, this fact is made known to the connection converting apparatus 104 by the hook detector 202. The connection converting apparatus 104 causes the relay 204 to be connected to the PSTN 120 again, and informs the PC 106 of this fact via a control data path. Then, the PC 106 informs the VoIP gateway 140 of this fact and disconnects the communication path. The VoIP gateway 140 disconnects the communication path in the mobile communication network and informs IHP server 132 of the end of the call.

According to the present invention, because it is possible to allow a general telephone to communicate with a mobile phone and a telephone without using the PSTN, cost of using the PSTN can be reduced. The IHP provider can make the call charges by managing the call records. Though the IHP provider and the mobile communication network provider are separately described in the present embodiment, the mobile communication network provider may be an IHP provider.

The process of establishing a call from a mobile phone to a telephone according to the present invention is depicted in FIG. 6.

Referring to FIG. 6, a calling party dials a number of a telephone using a mobile phone 154.

The number is sent to the VoIP gateway 140 of a mobile communication network, and requests information for whether the receiving party is in a state of accessing the Internet. If the receiving party is in an on-line state, the VoIP gateway 140 requests an IP address of the receiving party.

When the IP address of a computer of the receiving party is received from the IHP server 132, the VoIP gateway 140 sends a packet for requesting the call to that IP address. As the result, the Internet phone software of the computer of the receiving party informs the connection converting apparatus 104 of the call request.

When the receiving party is informed of the call request by means of the speaker 214 or the LED 219 of the connection converting apparatus 104, the receiving party takes a handset of the telephone off the hook. Then, information regarding this state of the telephone is provided to the VoIP gateway 140 through the PC 106, so that a communication path is formed between the calling and receiving parties.

A voice signal generated from the mobile phone of the calling party is sent to the VoIP gateway 140 through the mobile communication network 150. The voice data are loaded on IP packets and provided to the computer of the receiving party through the Internet 110. The computer of the receiving party reproduces the original voice data based on the IP packets. The soundcard 106b demodulates the voice data, generates an analog voice signal and provides the analog voice signal to the telephone 102 through the connection converting apparatus 104.

An analog voice signal of the receiving party generated by the telephone is provided to the soundcard 106b of the PC through the duplex circuit 206 of the connection converting apparatus 104, and coded into digital data by the soundcard 106b. The voice data coded by the soundcard 106b are broken up into IP packets by the Internet phone software 106c and sent to the VoIP gateway 140 via the Internet. The VoIP gateway 140 rearranges the IP packets to reproduce the voice data, and sends the voice data to the calling party through the mobile communication network. In order to inform the IHP provider 130 of the call time between the calling and receiving parties, the VoIP gateway 140 provides the IHP provider 130 with information regarding the generation of the dial tone signal and the call.

On the other hand, when the computer of the receiving party is turned off (or in an off-line state), the IHP server 132 informs the VoIP gateway 140 of the fact that the computer is turned off. When the receiving party is in an off-line state, the VoIP gateway 140 originates the call to the receiving party through the PSTN 120 as in the prior art.

Second Embodiment

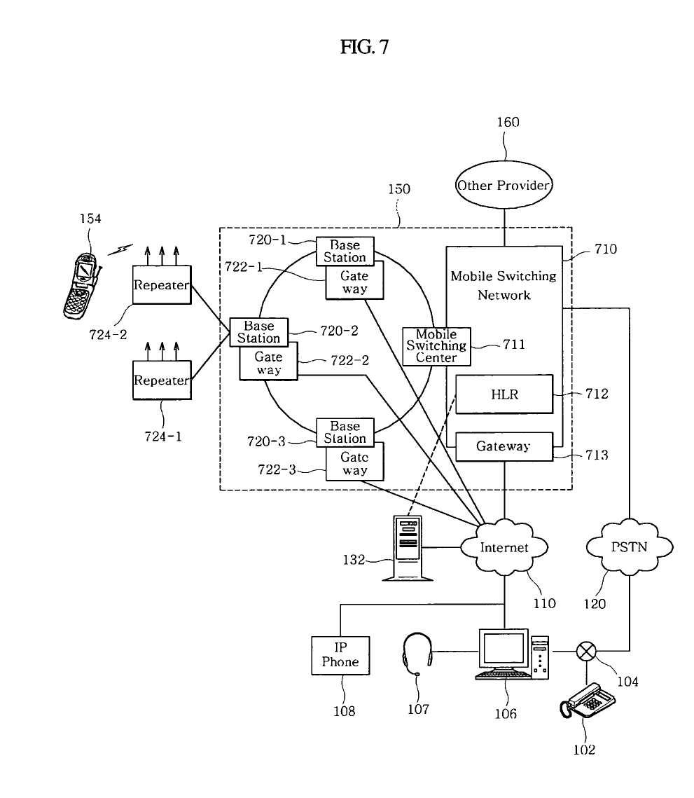

FIG. 7 is a view showing an overall structure of an Internet phone system according to the second of the present invention.

Referring to FIG. 7, a telephone 102 is connected to a PC 106 and PSTN 120 via a connection converting apparatus 104. The PC 106 is connected with the Internet via a very high-speed communication network. A provider's server 132 providing a service for connecting the telephone 102 with a mobile phone via the Internet according to the present invention is connected with the Internet 110 and a DB 712 of the mobile communication service provider. The mobile communication service provider 150 manages a pre-existing mobile communication network. The mobile communication network 710 according to the present invention includes a mobile switching center 711 of a mobile switching network 710 and base stations 720-1 through 720-3, and gateways 722-1 through 722-3, being connected with the Internet, are installed in the base stations 720-1 through 720-3, respectively. Each of the mobile communication networks 710 includes a network of MSCs, an HLR 712 having a database of subscriber location information, a dedicated network for a fee charging, and a network management system.

The base stations 720-1 through 720-3 of the present provider provide a mobile telephone service to subscribers of the present provider through repeaters 724-1 and 724-2. The networks of the present provider and at least one other provider 160 are connected with each other through the mobile switching network 710.

The PC 106, which has the same structure as that of FIG. 1, includes a very high-speed modem for accessing the Internet and a sound card. A driver, an operation system (O/S), and various application programs are installed in the PC 106. Internet phone software is installed in the PC 106 particularly for performing the service according to the present invention.

In the second embodiment mentioned above, the difference with the first embodiment is that the base stations 720-1 through 720-3 are installed in the VoIP gateways 722-1 through 722-3, respectively.

In this configuration, a calling party dials a number of a receiving party, for example, “019-239-0021”, using the telephone.

The connection converting apparatus 104 sends the number of the receiving party to the Internet phone service provider server 132 through the user's computer. The IHP server 132 first analyzes the number to determine whether the receiving party is subscribed to any mobile communication service provider, and then accesses a HLR of the mobile communication network to which the receiving party is subscribed on order to search for information about the location of the receiving party (information about the location of each base station). Then, the IHP server 132 sends a call setup signal to the VoIP gateways 722-1 through 722-3 of the destination base station. The VoIP gateways 722-1 through 722-3 analyze Internet packets to detect the number of the receiving party and call the receiving party through a paging channel. At this time, if the receiving party is busy, this fact is sent through a reverse path to the calling party.

When the receiving party connects the mobile phone 154, taking it “off the hook”, a communication path is established between the VoIP gateways 722-1 through 722-3 of the base station and the mobile phone. The VoIP gateway 722-1 through 722-3 of the base station sends response packets to the IHP server 132 and a network management server to inform the IHP server 132 and the network management server that the mobile phone is connected (for the charging of a fee). The IHP server 132 again sends the packets to the PC 106 of the calling party. Then, the Internet phone software of the PC sends the packets to the connection converting apparatus 104 and establishes a communication path between the calling and receiving parties.

On the other hand, when a call is completed and the mobile phone is hung up, the hook detector informs the connection converting apparatus 104 of the fact that the call has been completed, so that the connection converting apparatus 104 is again connected to the PSTN 120. Further, the connection converting apparatus 104 informs the PC 120 of the fact through a control data path that the mobile phone is hung up. Then, the PC 106 sends this information to the VoIP gateway 722-1 through 722-3 of the base station and disconnects the communication path. Further, the VoIP gateway 722-1 through 722-3 of the base station disconnects the communication path between the receiving party and itself and informs the mobile communication service provider and the IHP provider that the call is completed.

According to the present invention, by allowing a common telephone to be connected to the mobile phone not through the PSTN but through the Internet, it is possible to remove a cost due to use of the PSTN. Also, the HP provider can make the call charges by managing the call records. Though the IHP provider and the mobile communication network provider are separately described in the present embodiment, the mobile communication network provider may be an IHP provider.

Hereinafter, the process of establishing a call from the mobile phone to the telephone will be described.

A calling party dials a number of a telephone using the mobile phone. When the number is dialed, the VoIP gateway 722-1 through 722-3 of a destined base station is connected to the IHP server 132, and requests information for whether the receiving party is in a state of accessing the Internet and information regarding an IP address of a computer of the receiving party. When the IP address of the computer of the receiving party is received from the IHP server 132, the VoIP gateways 722-1 through 722-3 send a packet for requesting the call to the IP address. As a result, the Internet phone software of the PC 106 of the receiving party informs the connection converting apparatus 104 of the call request.

When the receiving party is informed of the call request by means of the speaker or the LED of the connection converting apparatus 104, the receiving party hangs up a handset of the telephone to be connected. Then, information regarding this state the telephone is provided to the VoIP gateways 722-1 through 722-3 through the PC 106, so that a communication path is formed between the calling and receiving parties.

On the other hand, when the computer of the receiving party is turned off (or in an off-line state), the IHP server 132 informs the VoIP gateway 722-1 through 722-3 of the fact that the computer is turned off. When the receiving party is in an off-line state, the VoIP gateway 722-1 through 722-3 originates the call to the receiving party through the PSTN 120 as in the prior art.

According to the present invention, because it is possible to allow a general telephone to communicate with a mobile phone without the PSTN, call fees can be reduced. Further, the present invention has an advantage in that by providing two communication paths through the PSTN and the Internet, even if any one of two communication networks is cut off, a communication path can be established through other forms of communication.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed:

1. A method of providing an Internet phone service comprising the steps of:
installing software to a wire terminal, wherein the wire terminal is automatically connected to a mobile communication network by the software when the wire terminal becomes off the hook; and
connecting the wire terminal to a mobile terminal not via PSTN but via the Internet.

2. An Internet phone system for a mobile communication comprising:
a telephone;
a connection converting apparatus for connecting the telephone to either the Internet or a PSTN;
a user's computer in which software is installed for connecting the telephone to the Internet through the connection converting apparatus;
a VoIP gateway for connecting a mobile communication network to the Internet; and
a mobile telephone capable of accessing the Internet.

3. The Internet phone system as claimed in claim 2, wherein the connection converting apparatus includes:
a hook detector for detecting a hooking state of the telephone;
a relay for connecting the telephone to either the Internet or the PSTN, according to a command;
a duplex circuit for suppressing voice leakage and side tone by converting and reconverting from a two-line telephone signal to a four-line signal for transmission and reception;
a tone decoder for decoding a DTMF tone signal of the telephone; and
a microprocessor for exchanging control data for the user's computer, controlling the relay to cause the telephone to be connected to the Internet when the hook detector detects an off-the-hook state of the telephone, and providing number data to the user's computer when the microprocessor receives number data from the tone decoder.

4. The Internet phone system as claimed in claim 3, wherein the connection converting apparatus further comprises:
a mode key for setting the telephone to either an Internet phone mode or a general telephone mode; and
a ring detector for detecting a ring signal from the PSTN and providing the ring signal to the microprocessor.

5. The Internet phone system as claimed in claim 4, wherein the connection converting apparatus further comprises:
a switch for driving a speaker phone;
an on-board speaker;
an on-board microphone; and
an analog switch for providing a voice signal from the computer to the on-board speaker and connecting a transmitting end to the microphone according to a command from the microprocessor.

6. The Internet phone system as claimed in claim 2, further comprising an intermediate site for mediating between a user and the mobile communication network.

7. The Internet phone system as claimed in claim 2, wherein the VoIP gateway is a central concentrating type.

8. The Internet phone system as claimed in claim 2, wherein the VoIP gateway is installed at a base station of the mobile communication network.

9. A method of providing an Internet phone service, wherein the method allows a user of a telephone to communicate with a subscriber of a mobile communication network by a process of originating a call or a process of receiving a call requested by a subscriber of the mobile communication network, the method including an originating process and a receiving process,
the originating process comprising the steps of:
receiving an IP address when the telephone is off the hook and inputting a number of a mobile phone;
transmitting the number of the mobile phone and the IP address to a VoIP gateway of a mobile communication network defined by the number in order to request a call; and
performing a predetermined call process by the VoIP gateway in order to connect the telephone with the mobile phone;
and the receiving process comprising the steps of;
determining whether the computer of a user of the telephone is in an on-line state when the subscriber calls the user of the telephone;
calling the telephone of the user using an IP address when the computer is in the on-line state; and
allowing the telephone and the mobile phone to communicate with each other when the user takes the telephone off the hook in response to the call, so that the user may communicate with the subscriber not via a PSTN but via the Internet.

10. The method as claimed in claim 9, wherein the receiving process further comprises the step of allowing the telephone to be connected via a PSTN when the computer is not in an on-line state.
